(19) United States
(12) Patent Application Publication
(10) Pub. No.: US 2004/0064658 A1
(43) Pub. Date: Apr. 1, 2004

(54) Access control method and apparatus for a raid storage device

(75) Inventor: Jack Chang, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Dynapac Corporation

(21) Appl. No.: 10/309,959

(22) Filed: Dec. 4, 2002

(30) Foreign Application Priority Data
Sep. 27, 2002 (TW) 091122410

(51) Int. Cl. G06F 12/00; G06F 12/16

(52) U.S. Cl. 711/162; 711/114

(57) ABSTRACT

An access control method and apparatus for a RAID storage device that includes a data hard disk and a backup hard disk are disclosed herein. In response to a write command, data associated with the write command is written onto the data hard disk and the backup hard disk concurrently. Moreover, in response to a read command, data corresponding to the read command is read from the data hard disk, and the data read from the data hard disk is written concurrently onto the backup hard disk.

### CROSS-REFERENCE TO RELATED APPLICATION

This application claims priority of Taiwanese Application No. 091122410, filed on Sep. 27, 2002.

### BACKGROUND OF THE INVENTION

1. Field of the Invention

The invention relates to an access control method and apparatus for a RAID storage device, more particularly to an access control method and apparatus for controlling and managing access of data in a RAID storage device so as to prevent access of ambiguous backup data during data reconstruction, thereby ensuring integrity of the accessed data.

2. Description of the Related Art

The rapid growth of networks and servers in recent years has resulted in greater demands for data security. In addition to the important task of making daily backups of data on magnetic tape or other forms of storage media, it is also desirable to shorten the time of data restoration in the event of hard disk failure. Redundant Arrays of Inexpensive/Independent disks (RAID) technology, which provides disk fault tolerance and ease of management, has been proposed heretofore. Referring to FIG. 1, a RAID storage device 11 is disposed in a host system 1, such as a computer, and is constituted by arrays of hard disks 111d, 112d. Software installed in a control block 12 in the host system 1 is used to configure the storage device 11 into a single virtual hard disk. The set of hard disks 111d forms a data hard disk 111, whereas the set of hard disks 112d forms a backup hard disk 112 for storing redundant information. The hard disks 111d, 112d communicate with other devices through a storage interface 13, such as an IDE interface.

When a processor (not shown) in the host system 1 generates a write command associated with a store process 14, data is stored simultaneously on one of the hard disks 111d and one of the hard disks 112d through the storage interface 13 so as to perform a data backup operation concurrent with execution of the store process 14. Therefore, if one of the hard disks 111d fails, the backup data stored on a corresponding one of the hard disks 112d can be retrieved to replace the corrupted data. Furthermore, when it is desired to install a new hard disk 112d′, upon detection by the processor in the host system 1 of the new hard disk 112d′, a backup process 15 will be automatically executed for making a backup copy of data to be stored on the new hard disk 112d′. The backup process 15 includes read and write operations, i.e., reading in sequence data to be copied from a corresponding source hard disk 111d, and writing in sequence the data that was read onto the target hard disk 112d′ to thereby complete a backup operation.

During the backup operation, if the store process 14 is executed to write data (A′) onto one of the hard disks 111d at a position where data (A) originally resides so as to overwrite the original data (A), the data (A′) will be written onto the corresponding hard disk 112d′ of the backup hard disk 112 simultaneously. However, when the store process 14 and the backup process 15 are executed concurrently, the data copied to and stored on the hard disk 112d′ may be data (A) or data (A′), depending on the sequence of execution of the store and backup processes 14, 15. Thus, ambiguous backup data may be generated in the RAID storage device 11 during reconstruction of data, thereby resulting in backup data error.

To solve the aforesaid problem, a RAID controller for controlling access of data in a RAID storage device was proposed. The RAID controller 20 is disposed in a host system 2, and cooperates with the RAID storage device 21 and a storage interface 23 to constitute an architecture, such as that shown in FIG. 2. FIG. 3 is a flowchart illustrating control of data access operations of the RAID storage device 21 by the RAID controller 20. Initially, in step 30, it is determined whether a command is issued by the host system 2. In the negative, the flow goes back to step 30. The flow is terminated if no command is issued within a predetermined period of time. If a processor (not shown) of the host system 2 issues a command, the type of the command is determined in steps 31, 32, 33 and 34. If it is determined in step 31 that the command is a read command, the flow proceeds to step 311 to determine whether the data block corresponding to the read command is in a locked state. In the affirmative, the flow returns to step 30 to determine whether any other command is issued by the host system 2. If the corresponding data block is not locked, the flow proceeds to step 312 to read the data from the block. Then, in step 313, the data block is locked so as to prevent access thereto. The flow returns to step 30 to determine whether any other command is issued by the host system 2. If it is determined in step 32 that the command is a write command, the flow proceeds to step 321 to determine whether the data block corresponding to the write command is in a locked state. In the affirmative, the flow returns to step 30. Otherwise, step 322 is performed to write data corresponding to the write command onto the block, and the data block is subsequently locked in step 323 to prevent access thereto. Step 30 is once again repeated to determine whether there is any other command. If it is determined in step 33 that the host system 2 issued a command for unlocking a data block, step 331 is performed to unlock the block corresponding to the command so that the block is restored to an unlocked state to permit access thereto. Then, the flow goes to step 30 to determine whether there is any other command. If it is determined in step 34 that there is a reconstruct command, step 341 is performed to determine whether the data block to be reconstructed is in a locked state. In the affirmative, reconstruction of data is not permissible, and the flow returns once again to step 30. Otherwise, step 342 is performed to copy the data in the block to another hard disk. The aforesaid RAID controller 20 manages data access through locking and unlocking of the data blocks. The data blocks are locked after a write or read operation, and access to a data block to be reconstructed is not permissible before unlocking. As such, data cannot be copied to another hard disk immediately after modification thereof, and data access and reconstruction are permissible only after unlocking. Therefore, during reconstruction of data, two different sets of data will not be copied to a hard disk to avoid ambiguity of backup data. However, a method of control as such is complicated and time-consuming, and involves high hardware costs. In addition, since every command has to undergo several steps of determination before the corresponding operation can proceed, and since each determination of the state of the data block in the hard disk has to go through the memory interface, which occupies valuable memory bandwidth, the speed of control is relatively slow.

### SUMMARY OF THE INVENTION

Therefore, the main object of the present invention is to provide an access control method and apparatus for a RAID storage device, which ensures integrity of reconstructed data in the RAID storage device.

Another object of the present invention is to provide a method and apparatus for controlling access of data in a RAID storage device, which operates at a relatively fast speed, and which is simple and relatively low-cost.

According to one aspect of this invention, there is provided an access control method for a RAID storage device that includes a data hard disk and a backup hard disk. The access control method comprises the steps of:

a) in response to a write command, writing data associated with the write command onto the data hard disk and the backup hard disk concurrently; and

b) in response to a read command, reading data corresponding to the read command from the data hard disk, and concurrently writing the data read from the data hard disk onto the backup hard disk.

According to another aspect of this invention, there is provided an access control apparatus for a RAID storage device in a host system. The RAID storage device includes a data hard disk and a backup hard disk. The access control apparatus is responsive to write and read commands issued by a processor in the host system, and comprises:

a controller;

a first transmission device adapted to connect the controller to the processor and the data hard disk; and

a second transmission device adapted to connect the controller and the backup hard disk.

The controller is capable of receiving the write and read commands issued by the processor in the host system through the first transmission device. In response to the write command, the controller is configured to write data associated with the write command onto the data hard disk and the backup hard disk concurrently through the first and second transmission devices. In response to the read command, the controller is configured to read data corresponding to the read command from the data hard disk through the first transmission device, and to write concurrently the data read from the data hard disk onto the backup hard disk through the second transmission device.

According to yet another aspect of this invention, there is provided an access control apparatus for a RAID storage device in a host system. The RAID storage device includes a data hard disk and a backup hard disk. The access control apparatus is responsive to write and read commands issued by a processor in the host system, and comprises:

a controller;

a transmission device connected to the controller, adapted to be connected to the data hard disk, and adapted to establish a virtual channel with the processor; and

a storage interface adapted to connect the controller and the backup hard disk.

The controller is capable of receiving the write and read commands issued by the processor through the transmission device. In response to the write command, the controller is configured to write data associated with the write command onto the data hard disk and the backup hard disk concurrently through the virtual channel and the storage interface. In response to the read command, the controller is configured to read data corresponding to the read command from the data hard disk through the virtual channel, and to write concurrently the data read from the data hard disk onto the backup hard disk through the storage interface.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram depicting the relationship between a RAID storage device and other components in a conventional host system;

FIG. 2 is a schematic block diagram depicting the relationship between a RAID storage device and other components in another conventional host system;

FIG. 3 is an operational flowchart of a controller shown in FIG. 2, illustrating how access of data in the RAID storage device proceeds under the control of the controller;

FIG. 4 is a schematic block diagram illustrating the connection between an access control apparatus of the first preferred embodiment and components within a host system that incorporates a RAID storage device;

FIG. 5 is a flowchart to illustrate access control of the RAID storage device in the first preferred embodiment of the present invention;

FIG. 6 is a schematic block diagram illustrating the connection between an access control apparatus of the second preferred embodiment and a host system that incorporates a RAID storage device; and

FIG. 7 is a flowchart to illustrate access control of the RAID storage device in the second preferred embodiment of the present invention.

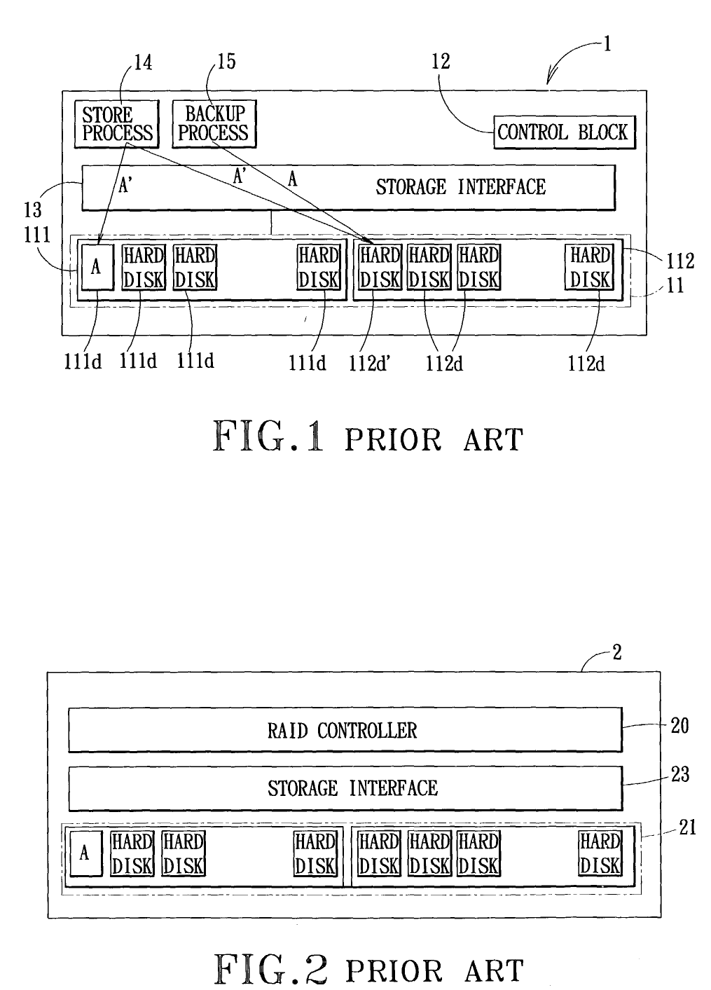

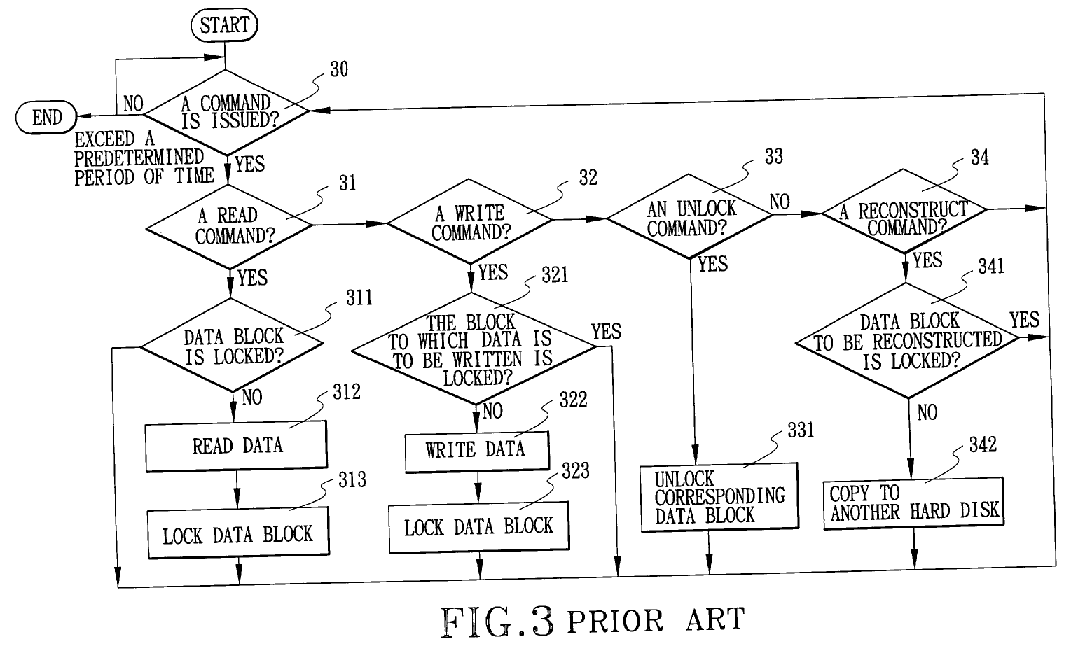

### DETAILED DESCRIPTION OF THE PREFERRED EMBODIMENTS

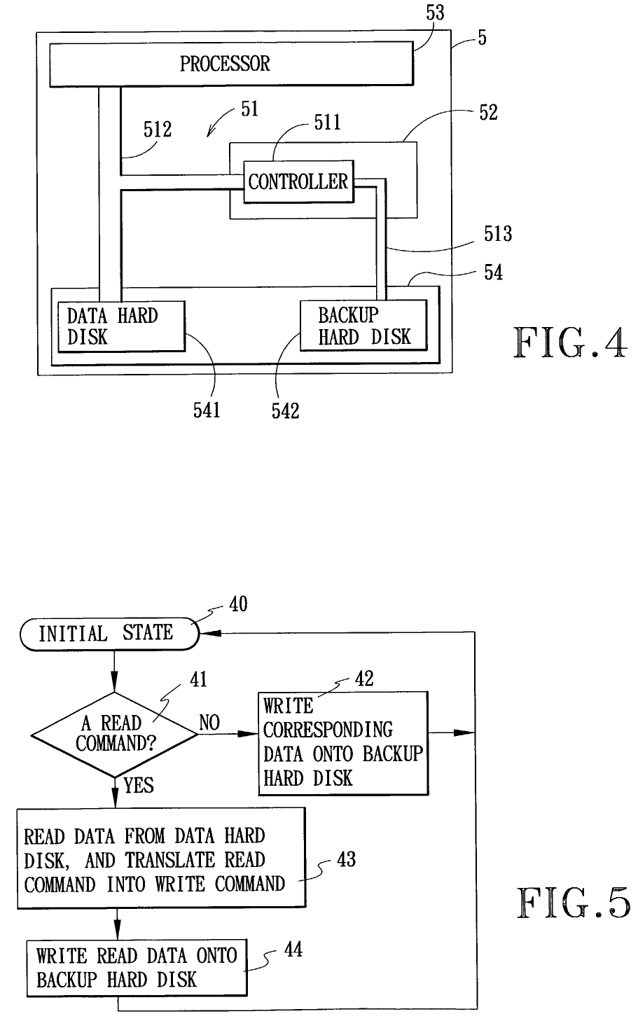

Referring to FIG. 4, the first preferred embodiment of an access control apparatus 51 of this invention is shown to be provided on a storage interface 52 disposed in a host system 5 for receiving commands from a processor 53 within the host system 5 so as to control access to a RAID storage device 54 disposed within the host system 5. A conventional RAID storage device 54 has a plurality of hard disks. Regardless of the RAID level, the hard disks of the RAID storage device 54 can be classified into data hard disks and backup hard disks. In the following embodiments, two blocks are used to represent the two classes of hard disks in the RAID storage device 54, i.e., a data hard disk 541 for data storage, and a backup hard disk 542 for backup data. Furthermore, the host system 5 applicable in the present invention is electronic equipment capable of receiving and processing video, audio and text data, such as a personal computer, a tablet personal computer, a notebook computer, a personal digital assistant, etc. In addition, the storage interface 52 can be an IDE interface, IEEE 1394, USB, or a SCSI interface.

In the first preferred embodiment, the access control apparatus 51 includes a controller 511, a first transmission device 512 connected to the processor 53, the controller 511 and the data hard disk 541, and a second transmission device 513 connected to the controller 511 and the backup hard disk 542. Each of the first and second transmission devices 512, 513 is preferably a bus. The controller 511 can be firmware incorporated on a storage interface card or software written onto the storage interface 52.

The control of access of data by the access control apparatus 51 will now be described with reference to FIGS. 4 and 5. When the user inputs a write or read command into the host system 5, the processor 53 will issue a corresponding write or read command. When one of the hard disks fails, and the user installs a new hard disk, the processor 53 will detect the new hard disk, and will perform reconstruction of data, in which the processor 53 automatically issues read and write commands, to make a backup copy of data to be stored in the new hard disk.

When the processor 53 has yet to receive any command from the user, the flow shown in FIG. 5 is in an initial state 40. When the user inputs a write command into the host system 5, the processor 53 issues a corresponding write command received by the controller 511 through the first transmission device 512. Step 41 is then performed, in which the controller 511 determines whether the command is a read command. In the negative, step 42 is performed to write data onto the data hard disk 541 and the backup hard disk 542 simultaneously through the first and second transmission devices 512, 513, respectively, thereby completing a write response control. Thereafter, the flow returns to the initial state 40 to await a next command.

When the user inputs a read command into the host system 5, the processor 53 issues a corresponding read command, which is also received by the controller 511 through the first transmission device 512. Then, step 41 is performed, in which the controller 511 determines whether the command is a read command. In the affirmative, step 43 is performed to read data from the data hard disk 541 at an address corresponding to the read command through the first transmission device 512. At the same time, the read command is translated into a write command for the backup hard disk 542. Subsequently, in step 44, according to the translated write command, the data read in step 43 is written onto the backup hard disk 542 through the second transmission device 513, thereby completing a read response control. Thereafter, the flow returns to the initial state 40.

Furthermore, when the processor 53 executes a backup process for automatic data reconstruction, data is read from the data hard disk 541 and is copied onto the backup hard disk 542. Therefore, when the processor 53 executes the backup process, it will also issue a read command to the data hard disk 541 received by the controller 511 through the first transmission device 512, so that step 41 is subsequently performed to determine whether the received command is a read command. Steps 43 and 44 are thereafter performed in sequence to complete the operation of backing up the designated data. Thereafter, the flow returns to the initial state 40.

In step 43 of the above-described flow, the translation of the read command into the write command by the controller 511 is conducted in accordance with the various types of set commands in the storage interface 52. For instance, in the IDE interface, a read command is a Read Sector, which becomes a Write Sector when translated into a write command, whereas in the SCSI interface, a read command is Read(6), which becomes Write (6) when translated into a write command. Since such translation techniques are well known in the art, a detailed description thereof is dispensed with herein for the sake of brevity.

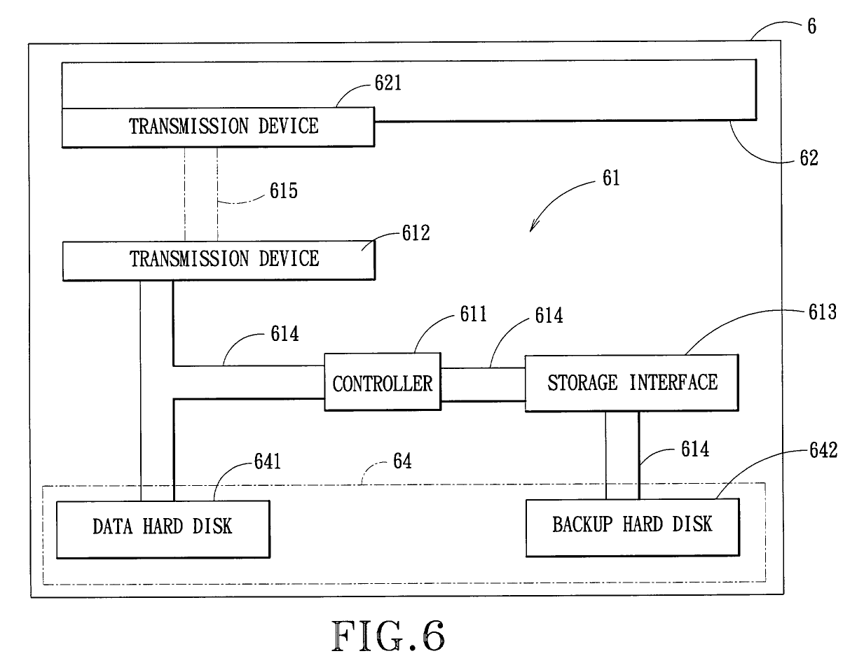

Referring to FIG. 6, the second preferred embodiment of an access control apparatus 61 according to the present invention is shown to include a controller 611, a transmission device 612 connected to the controller 611 and a data hard disk 641 of a RAID storage device 64, and a storage interface 613 connected to the controller 611 and a backup hard disk 642 of the RAID storage device 64. The storage interface 613 is connected to the controller 611 and the backup hard disk 642 through buses 614. The transmission device 612, the controller 611 and the data hard disk 641 are also interconnected through a bus 614.

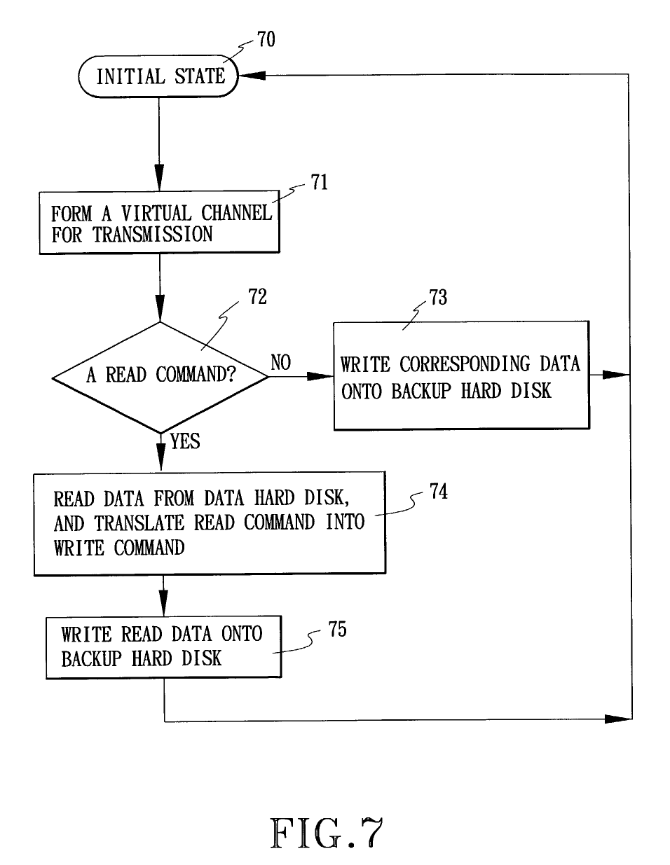

The control of access of data in the second preferred embodiment of the present invention will now be described with reference to FIGS. 6 and 7. Likewise, when the user inputs a read or write command into a host system 6, a processor 62 in the host system 6 will issue a corresponding read or write command. Furthermore, when one of the hard disks of the RAID storage device 64 fails, and the user installs a new hard disk, the processor 62 will detect the new hard disk, and will perform reconstruction of data, in which the processor 53 automatically issues read and write commands, to make a backup copy of data to be stored in the new hard disk.

When there is no command from the processor 62, the flow depicted in FIG. 7 is in an initial state 70. When the user inputs a write command into the host system 6, the processor 62 issues a corresponding write command, and step 71 is performed so that a virtual channel 615, such as that shown in FIG. 6, is formed between the transmission device 612 of the access control apparatus 61 and a transmission device 621 of the processor 62 for communication between the processor 62 and the access control apparatus 61. The write command is transmitted through the virtual channel 615 and the bus 614 for reception by the controller 611. As the construction of the virtual channel 615 using the two transmission devices 621, 612 is known in the art, a detailed description thereof is dispensed with herein for the sake of brevity. Thereafter, the flow goes to step 72, where the controller 611 determines whether the command is a read command. In the negative, step 73 is performed to write data onto the data hard disk 641 and the backup hard disk 642 simultaneously through the buses 614 and the storage interface 613, thereby completing a write response control. Subsequently, the flow returns to the initial state 70 to await a next command.

When the user inputs a read command, the processor 62 issues a corresponding read command, and step 71 is performed to transmit the read command to the controller 611 through the virtual channel 615 between the transmission device 612 of the access control apparatus 61 and the transmission device 621 of the processor 62. Then, in step 72, the controller 611 determines whether the command is a read command. In the affirmative, step 74 is performed, in which, according to the address contained in the read command, data corresponding to the address is read from the data hard disk 641 through the virtual channel 615. At the same time, the read command is translated by the controller 611 into a write command for the backup hard disk 642. Subsequently, in step 75, according to the write command translated in step 74, the data read in step 74 is written onto the backup hard disk 542 through the buses 614 and the storage interface 613, thereby completing a read response control. Thereafter, the flow returns to the initial state 70. Furthermore, when the processor 62 performs automatic reconstruction of data and issues a read command, the controller 611 will conduct data reconstruction according to the aforesaid read response control.

From the foregoing, it can be appreciated that the present invention utilizes the write and read commands received by the access control apparatus to respectively conduct write response control and read response control for managing the access of data in the RAID storage device. The present invention is therefore capable of clearly discerning the sequence or order of the commands to be executed, thereby ensuring the integrity of the accessed data and permitting access of determined data at a point of time.

To sum up, the access control method and apparatus for a RAID storage device according to the present invention manages the access of data in a RAID storage device by means of a simple control process at a reduced hardware cost. On the one hand, the present invention can enhance the control speed and efficiency. On the other hand, access of ambiguous backup data during data reconstruction can be avoided, thereby ensuring the integrity of accessed data.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An access control method for a RAID storage device that includes a data hard disk and a backup hard disk, comprising the steps of:
a) in response to a write command, writing data associated with the write command onto the data hard disk and the backup hard disk concurrently; and
b) in response to a read command, reading data corresponding to the read command from the data hard disk, and concurrently writing the data read from the data hard disk onto the backup hard disk.

2. The access control method of claim 1, wherein step b) includes:
reading the data from the data hard disk according to a read address associated with the read command;
translating the read command into a write command for the backup hard disk; and
writing the data read from the data hard disk onto the backup hard disk according to the translated write command.

3. The access control method of claim 1, wherein each of the write and read commands is issued in response to user operation of a host system.

4. The access control method of claim 1, wherein the write and read commands are issued by a host system during data reconstruction.

5. An access control apparatus for a RAID storage device in a host system, the RAID storage device including a data hard disk and a backup hard disk, said access control apparatus being responsive to write and read commands issued by a processor in the host system and comprising:
a controller;
a first transmission device adapted to connect said controller to the processor and the data hard disk; and
a second transmission device adapted to connect said controller and the backup hard disk;
said controller being capable of receiving the write and read commands issued by the processor through said first transmission device;
in response to the write command, said controller being configured to write data associated with the write command onto the data hard disk and the backup hard disk concurrently through said first and second transmission devices;
in response to the read command, said controller being configured to read data corresponding to the read command from the data hard disk through said first transmission device, and to write concurrently the data read from the data hard disk onto the backup hard disk through said second transmission device.

6. The access control apparatus as claimed in claim 5, wherein, in response to the read command, said controller is configured to read the data from the data hard disk according to a read address associated with the read command, to translate the read command into a write command for the backup hard disk, and to write the data read from the data hard disk onto the backup hard disk according to the translated write command.

7. The access control apparatus as claimed in claim 5, wherein each of said first and second transmission devices is a bus, and said controller is adapted to be implemented in a storage interface of the host system.

8. The access control apparatus as claimed in claim 5, wherein each of the write and read commands is issued in response to user operation of the host system.

9. The access control apparatus as claimed in claim 5, wherein the write and read commands are issued by the host system during data reconstruction.

10. An access control apparatus for a RAID storage device in a host system, the RAID storage device including a data hard disk and a backup hard disk, said access control apparatus being responsive to write and read commands issued by a processor in the host system and comprising:
a controller;
a transmission device connected to said controller, adapted to be connected to the data hard disk, and adapted to establish a virtual channel with the processor; and
a storage interface adapted to connect said controller and the backup hard disk;
said controller being capable of receiving the write and read commands issued by the processor through said transmission device;
in response to the write command, said controller being configured to write data associated with the write command onto the data hard disk and the backup hard disk concurrently through the virtual channel and said storage interface;
in response to the read command, said controller being configured to read data corresponding to the read command from the data hard disk through the virtual channel, and to write concurrently the data read from the data hard disk onto the backup hard disk through said storage interface.

11. The access control apparatus as claimed in claim 10, wherein, in response to the read command, said controller is configured to read the data from the data hard disk according to a read address associated with the read command, to translate the read command into a write command for the backup hard disk, and to write the data read from the data hard disk onto the backup hard disk according to the translated write command.

12. The access control apparatus as claimed in claim 10, wherein each of the write and read commands is issued in response to user operation of the host system.

13. The access control apparatus as claimed in claim 10, wherein the write and read commands are issued by the host system during data reconstruction.

14. The access control apparatus as claimed in claim 10, further comprising a set of buses for establishing connection among said controller, said transmission device, said storage device, and the data and backup hard disks of the RAID storage device.
